(19) United States
(12) Patent Application Publication
(10) Pub. No.: US 2008/0265749 A1
(43) Pub. Date: Oct. 30, 2008

(54) Phosphor-Converted Electroluminescent Device with Absorbing Filter

(75) Inventors: Hans-Helmut Bechtel, Roetgen (DE); Wolfgang Busselt, Roetgen (DE); Peter J. Schmidt, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/089,237

(22) PCT Filed: Sep. 25, 2006
(86) PCT No.: PCT/IB06/53472

§ 371 Date: Apr. 4, 2008

(30) Foreign Application Priority Data
Oct. 5, 2005 (EP) 05109243.5

(51) Int. Cl. H01J 1/62

(52) U.S. Cl. 313/503

(57) ABSTRACT

A phosphor-converted electroluminescent device comprising an electroluminescent light source (LED 2), for emitting primary radiation, a light-converting element (3) having a phosphor material for at least partly converting the primary radiation into secondary radiation, and a filter layer (7a, 7b, 7c, 7d) for absorbing that secondary radiation incident on the filter layer (7a, 7b, 7c, 7d) that lies beyond at least one boundary wavelength in the spectrum of the emitted secondary radiation.

The invention relates to an electroluminescent device having a phosphor layer for converting light and a filter layer for partly absorbing the converted light, and to the use of this light source in a vehicle.

Phosphor-converted electroluminescent devices (pcLEDs) having an electroluminescent light source (LED) and a light-converting phosphor layer, typically a layer of phosphor powder or a polycrystalline phosphor layer, are known. In pcLEDs of this kind, the LED emits primary radiation, at least part of which is absorbed by a phosphor layer arranged on the LED and is re-emitted as longer-wavelength secondary radiation. This process is also referred to as color conversion or light conversion. Depending on the application, either the whole of the primary radiation is converted into secondary radiation or else, when the conversion is only partial, it is possible for light of a different color, such as white light for example, to be produced by mixing primary and secondary radiation.

Document DE 10340005 discloses a pcLED device having a constant color point. The pcLED device has in this case an LED mounted on a substrate, and a transparent encapsulation made of a light-transmitting resin containing phosphor particles to change the color of the light emitted by the LED. The color point of the emitted light is altered by means of a dye that is introduced into the resin at a later stage. The spectrum that is produced in this way, comprising secondary radiation and a proportion of the primary radiation that depends on the transmission, covers a wide range of wavelengths, because the spectral width of the primary and second radiation is not altered by the dye. Specific applications, such as in the automotive industry or in indicator lights for example, call for light sources that emit in only a narrow region of the spectrum and that have a stable color point. The phosphors currently available for pcLEDs emit a spectral range that is too wide for such applications and of which the color points are not optimum.

It is therefore an object of the present invention to provide a phosphor-converted electroluminescent device that emits light in a narrow region of the spectrum and that has a stable color point.

This object is achieved by a phosphor-converted electroluminescent device comprising an electroluminescent light source for emitting primary radiation, a light-converting element having a phosphor material for at least partly converting the primary radiation into secondary radiation, and a filter layer for absorbing that secondary radiation incident on the filter layer that lies beyond at least one boundary wavelength in the spectrum of the emitted secondary radiation. What is referred to as a boundary wavelength is the wavelength as from which the filter layer absorbs more than 10% of the secondary radiation. The term “beyond” covers both possibilities of absorption, namely absorption below the boundary wavelength and absorption above the boundary wavelength. The absorption of light below the boundary wavelength includes complete absorption of the primary radiation in this case. By the absorption of an unwanted part of the spectrum of the secondary radiation the spectral range that is emitted can be limited in a defined way and a color point for emission that is substantially independent of possible variations in the emission maxima of the primary and secondary radiation can be set precisely. Because the emission of the secondary radiation takes place isotropically in the light-converting element, the emission of radiation from the light-converting element takes place over a wide angular range, partly even parallel to the surface of the electroluminescent light sources. The term “electroluminescent light source (or LED)” refers in this case to light sources having inorganic or organic electroluminescent layers.

In one embodiment, the filter layer absorbs the secondary radiation below a first boundary wavelength and above a second boundary wavelength. By means of a first, lower boundary wavelength and a second, upper boundary wavelength, light sources for applications that require a narrow-band emission spectrum can be produced. Because of the narrowness of the emission spectrum, the color point is even more precisely defined or the color point can be deliberately shifted into the desired range.

In one embodiment, the light-converting element is coupled to the electroluminescent light source optically. By means of this coupling, the primary radiation is coupled into the light-converting element in an improved way for effective conversion into secondary radiation.

In a further embodiment, the filter layer is arranged on that side of the light-converting element that is remote from the electroluminescent light source. What is achieved by the coating of that side of the light-converting element that is remote from the electroluminescent light source is that the secondary radiation emitted from the light-converting element is acted on as desired by the absorbing action of the filter layer. In an alternative arrangement, the filter layer is arranged not on the light-converting element but on an optical device that is situated on the path followed by the light emitted by the electroluminescent light source or that at least partly encloses the electroluminescent light source and the light-converting element. An optical device of this kind may for example be a lens or a light guide.

The filter layer comprises in this case at least one material from the group of inorganic or organic pigment materials. In a preferred embodiment, the pigment material is thermally stable up to 200° C., which makes it possible for use to be made of electroluminescent light sources having a high power density, so-called power LED's. What is obtained as a result of the thermal stability of the pigment material in the filter layer is a stable filtering action and thus a stable color point over the working life of the phosphor-converted electroluminescent device. Materials having a thermal stability of this kind comprise materials from the group comprising CoO—Al₂O₃, TiO₂—CoO—NiO—ZrO₂, CeO—Cr₂O₃—TiO₂—Al₂O₃, TiO₂—ZnO—CoO—NiO, Bi-vanadate, (Pr,Z,Si)—O, (Ti,Sb,Cr)—O, Ta oxinitride, Fe₂O₃, (Zn,Cr,Fe)—O, CdS—CdSe, TaON or ultramarine (Na₈₋₁₀Al₆Si₆O₂₄S₂₋₄). The materials shown with hyphens are mixed oxides such as are frequently used to produce inorganic pigments.

In another embodiment, the filter layer comprises a layer system comprising layers having alternately high and low refractive indexes. An interference filter of this kind provides exact adjustability of the boundary wavelength for different applications. One or more layers may also have light-absorbent properties in this case.

In another embodiment, the light-converting element has a transmission of more than 30% for secondary radiation having a direction of propagation parallel to the normal to the surface of the light-converting element, which increases the efficiency with which the secondary radiation is emitted by reducing the absorption of the secondary radiation in the light-converting element or in the surroundings. What is referred to as the normal to the surface is the vector that stands perpendicular to the surface of the light-converting element. Phosphor-converted electroluminescent devices having filter layers require a particularly high light yield when the secondary radiation is emitted to obtain the required intensity of the transmitted radiation because a part of the quantity of light is lost as a result of the absorbing action of the filter layer.

This efficiency can be achieved by a phosphor material in the form of a polycrystalline ceramic having a density greater than 95% of the theoretical density of the solid or in the form of a phosphor monocrystal. Phosphor materials of this kind have a low scattering power for secondary radiation and hence an increased light yield for secondary radiation. In an alternative efficient embodiment, the light-converting element comprises a matrix material having phosphor material embedded in it, in which case the refractive indexes of the matrix material and the phosphor material differ by less than 0.1.

The phosphor materials that are preferably used in the efficient embodiments comprise at least one material from the groups

(M^{I}_{1-x-y}M^{II}ₓM^{III}_{y})₃(Al_{1-z-v}M^{IV}_{z}M^{V}ᵥ)₅O₁₂₋ᵥNᵥ

where M^{I}=(Y, Lu); M^{II}=(Gd, La, Yb); M^{III}=(Th, Pr, Ce, Er, Nd, Eu); M^{IV}=(Ga, Sc) and M^{V}=(Si, Ge) and 0≦v≦1; 0≦x≦1; 0≦y≦0.1 and 0≦z≦1,

M^{I}ₓ^{v+}Si₁₂₋₍ₘ₊ₙ₎Alₘ₊ₙOₙN₁₆₋ₙ,

where M^{I}=(Li, Mg, Ca, Y, Sc, Ce, Pr, Nf, Sm, Eu, Gd, Th, Dy, Ho, Er, Tm, Yb, Lu) and x=m/v,

(M^{I}_{1-x-y}M^{II}ₓM^{III}_{y})₂O₃

where M^{I}=(Y, Lu); M^{II}=(Gd, La, Yb) and M^{III}=(Th, Pr, Ce, Er, Nd, Eu, Bi, Sb) and 0≦x≦1 and 0≦y≦0.1,

(M^{I}_{1-x-y}M^{II}ₓM^{III}_{y})S_{1-z}Se_{z}

where M^{I}=(Ca, Sr, Mg, Ba); M^{II}=(Ce, Eu, Mn, Th, Sm, Pr, Sb, Sn) and M^{III}=(K, Na, Li, Pb, Zn) and 0≦x≦0.01; 0≦y≦0.05 and 0≦z≦1,

(M^{I}_{1-x-y}M^{II}ₓM^{III}_{y})O

where M^{I}=(Ca, Sr, Mg, Ba); M^{II}=(Ce, Eu, Mn, Th, Sm, Pr) and M^{III}=(K, Na, Li, Pb, Zn) and 0≦x≦0.1 and 0≦y≦0.1,

(M^{I}₂₋ₓM^{II}ₓSi₂O₂N₂

where M^{I}=(Ca, Sr, Mg, Ba); M^{II}=(Ce, Eu, Mn, Th, Sm, Pr, Yb) and

(M^{I}₂₋ₓM^{II}ₓSi_{5-y}M^{III}_{y}O_{y}N_{8-y}

where M^{I}=(Ca, Sr, Mg, Ba); M^{II}=(Ce, Eu, Mn, Th, Sm, Pr, Yb) and M^{III}=(Al, B, Sc, Ga) and 0≦x≦0.1 and 0≦y≦4,

(M^{I}₂₋ₓM^{II}ₓM^{III}₂)O₇

where M^{I}=(La, Y, Gd, Lu, Ba, Sr); M^{II}=(Eu, Th, Pr, Ce, Nd, Sm, Tm) and M^{III}=(Hf, Zr, Ti, Ta, Nb) and 0≦x≦1,

(M^{I}₁₋ₓM^{II}ₓM^{III}_{1-y}M^{IV}_{y})O₃

where M^{I}=(Ba, Sr, Ca, La, Y, Gd, Lu); M^{II}=(Eu, Th, Pr, Ce, Nd, Sm, Tm); M^{III}=(Hf, Zr, Ti, Ta, Nb) and M^{IV}=(Al, Ga, Sc, Si) and 0≦x≦0.1 and 0≦y≦0.1.

What notation such as for example M^{I}=(Ca, Sr, Mg, Ba) for M^{I} is intended to mean in this case is not only the individual elements but also mixtures of the elements that are shown in parentheses.

In a further embodiment, the phosphor material is a Lumogen material. What are referred to as Lumogens are highly efficient organic dyes, typically based on perylene dyes.

The invention also relates to the use of a phosphor-converted electroluminescent device as claimed in claim 1 as a light source in a vehicle. In the automotive area, tight spectral ranges are required for the emission of light sources for certain applications.

These and other aspects of the invention are apparent from and will be elucidated with reference to the embodiments described hereinafter.

In the drawings:

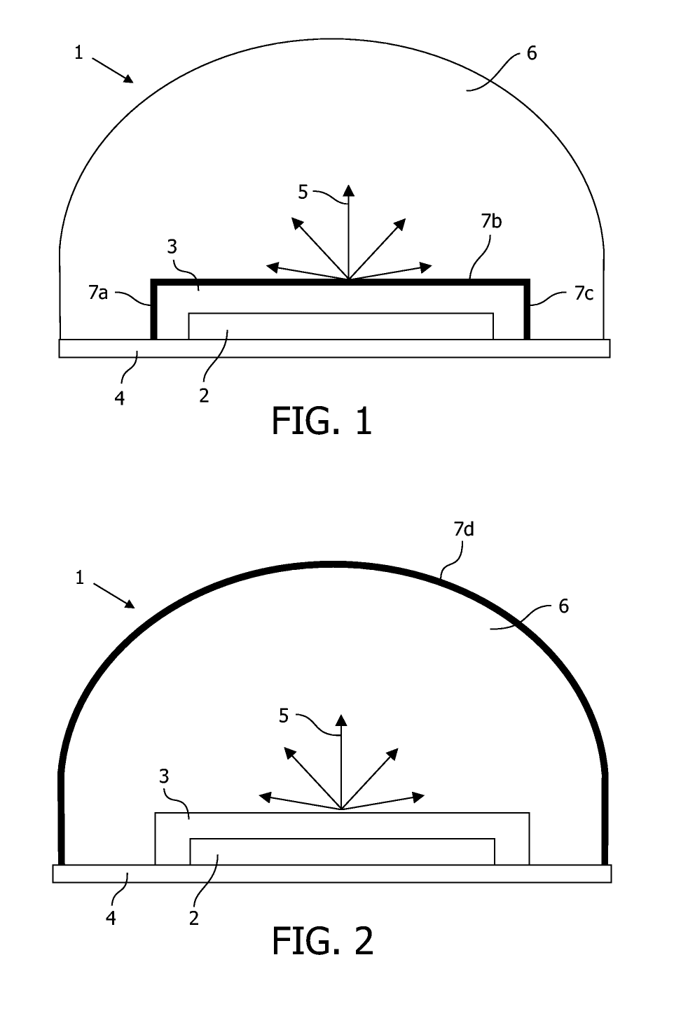

FIG. 1 shows an embodiment of the phosphor-converted electroluminescent device according to the invention, having a filter layer arranged on the light-converting element.

FIG. 2 shows an alternative embodiment of the phosphor-converted electroluminescent device according to the invention, having a filter layer arranged on a lens.

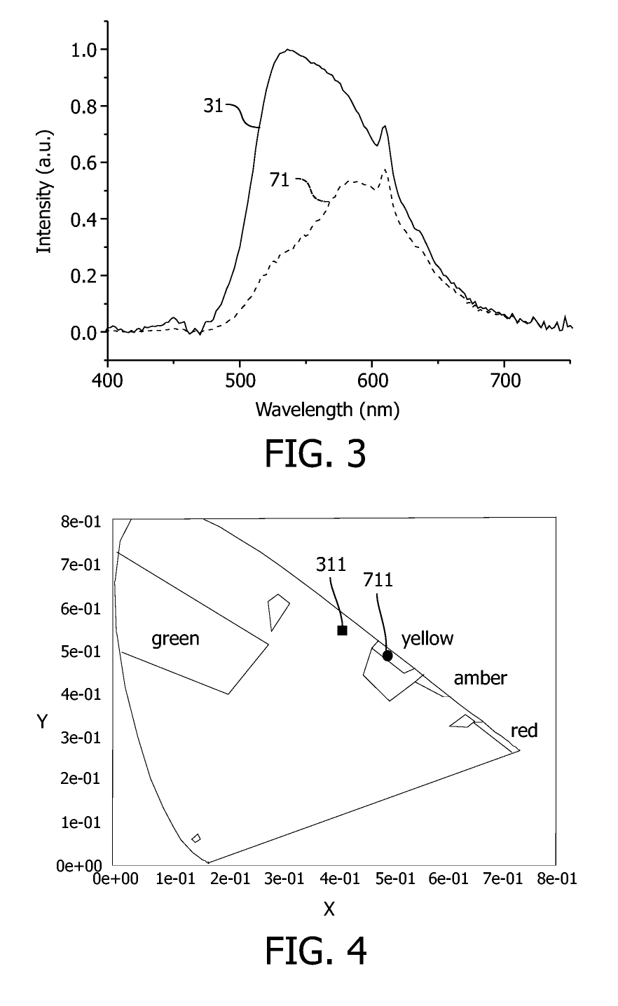

FIG. 3 shows the intensity distribution with and without an Fe₂O₃ filter layer for a blue LED having a light-converting element made of (Y_{0.7}Gd_{0.3})₃Al₅O₁₂:Ce(1%), Pr(0.1%).

FIG. 4 shows the color points of the pcLED from FIG. 3 in the CIE1931 diagram with definitions entered for signal colors.

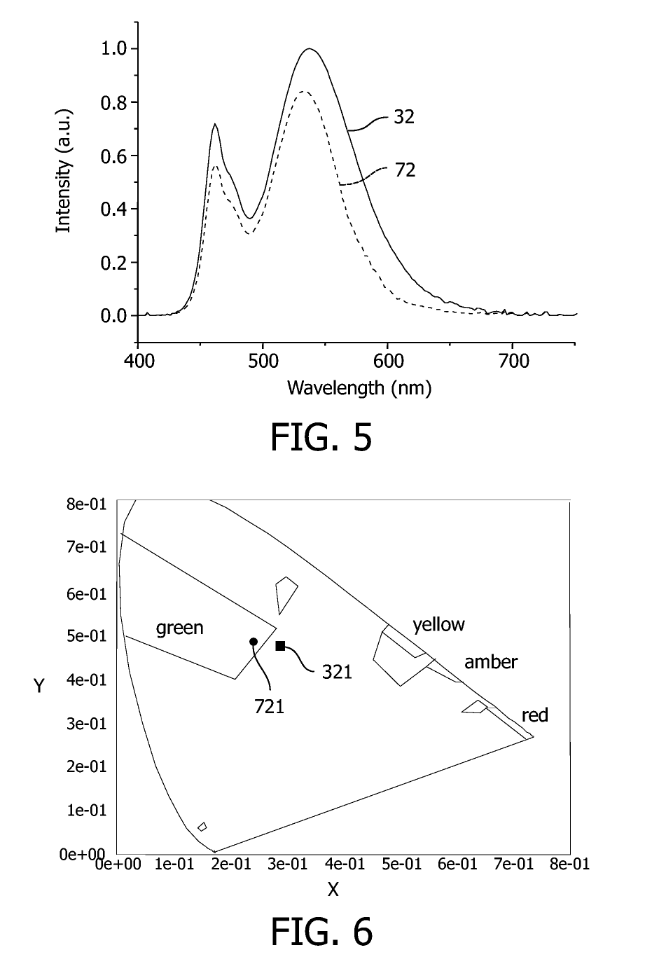

FIG. 5 shows the intensity distribution with and without a TiO₂—ZnO—CoO—NiO filter layer for a blue LED having a light-converting element made of SrSi₂O₂N₂:Eu(2%).

FIG. 6 shows the color points of the pcLED from FIG. 5 in the CIE1931 diagram with definitions entered for signal colors.

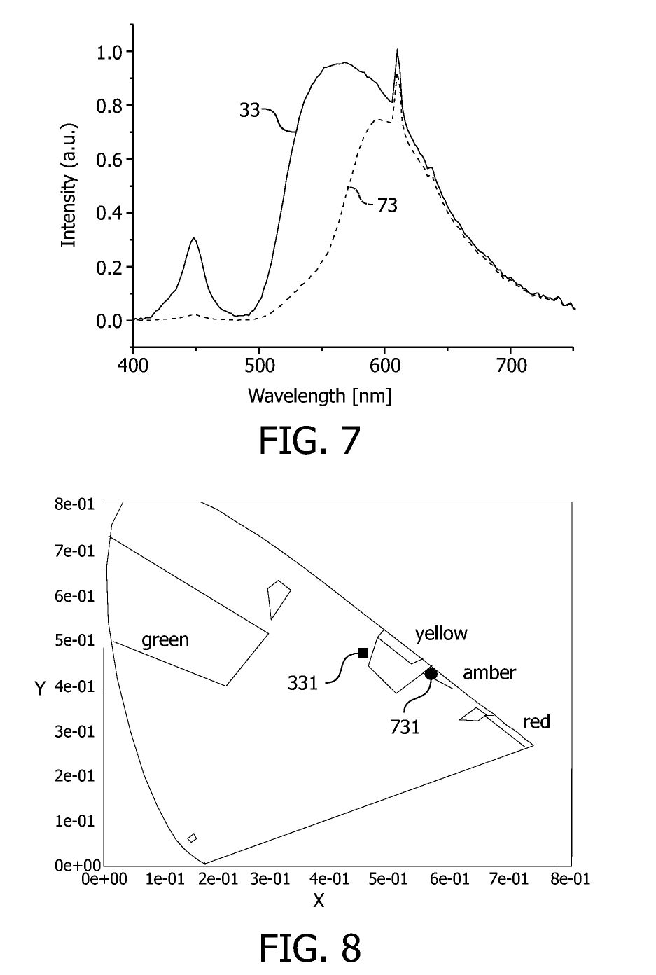

FIG. 7 shows the intensity distribution with and without a TaON filter layer for a blue LED having a light-converting element made of (Y_{0.7}Gd_{0.3})₃Al₅O₁₂:Ce(1%), Pr(0.2%).

FIG. 8 shows the color points of the pcLED from FIG. 7 in the CIE1931 diagram with definitions entered for signal colors.

FIG. 1 shows a phosphor-converted electroluminescent device 1 according to the invention having an electroluminescent light source 2 (LED) that is applied to a base 4 and that has for example an inorganic or organic electroluminescent layer (not shown here in detail) to emit primary radiation, and a light-converting element 3 arranged on the LED 2 for the at least partial conversion of the primary radiation into secondary radiation, said light-converting element 3 having a direction of emission 5, and a filter layer 7a, 7b, 7c for absorbing the secondary radiation at least beyond a boundary wavelength in the spectrum of the secondary radiation emitted, which filter layer 7a, 7b, 7c is arranged on the side of the light-converting element 3 remote from the LED 2 in this embodiment. The side-faces of the light-converting element, for the application of regions 7a and 7c of the filter layer, may also, as an alternative to the filter layer, be covered with a reflective layer. If this were the case the filter layer would extend only over the region 7b. The phosphor-converted electroluminescent device may, in addition, comprise an optical device 6, which is a lens in this embodiment. In other embodiments, the optical device may also take the form of for example a light guide or a system of reflectors. The filter layer may have a first and a second boundary wavelength, for the absorption of the secondary radiation below the first and above the second boundary wavelength. For this purpose, the filter layer may also comprise two or more sub-filter-layers each having at least one boundary wavelength.

FIG. 2 shows a different embodiment according to the invention in which the filter layer 7d is applied not to the light-converting element 3 (as in FIG. 1), but to the lens 6. This lens 6 may be composed of a compact transparent material, which means that the filter layer 7d is applied (as shown in FIG. 2) to that surface of the lens 6 that is on the outside looking in the direction of emission 5. Alternatively, it is possible for a lens 6 of this kind not to completely fill the space at the boundary between it and the light-converting element 3, which means that the lens 6 also has an inside surface (in contrast to the outside surface) that is adjacent the light-converting element 3 and to which the filter layer 7d may equally well be applied.

An electroluminescent light source 2 comprises a substrate, such as sapphire or glass for example, and an electroluminescent layered structure applied to the substrate that has at least one organic or inorganic electroluminescent layer that is arranged between two electrodes. The phosphor-converted electroluminescent device 1 may also comprise in this case a plurality of electroluminescent light sources 2 for emitting the same and/or different primary radiation. The light-converting element 3 is arranged in this case on the beam path of the primary radiation to at least partially absorb the said primary radiation. It may be applied directly to the electroluminescent light source 2 in this case or may be optically coupled to the electroluminescent light source 2 by means of transparent materials. For the optical coupling of the light-converting element 3 to the electroluminescent light source 2, there may for example be used between the light-converting element 3 and the electroluminescent light source 2 adhesion layers made of elastic or hard materials having a refractive index for the primary radiation of between 1.4 and 3, such as for example addition cross-linked cross-linkable two-component silicone rubbers or even glass materials that are connected to the light source and the light-converting element at high temperatures. As well as this, it is also particularly advantageous if the light-converting element 3 is brought into close contact with the electroluminescent light source 2 so that the distance between the two is, on average, less than 30 times the mean wavelength of the primary radiation, and preferably less than 10 times, and particularly preferably less than 3 times the mean wavelength. In other embodiments, however, a plurality of light-converting elements that differ in their arrangement, size, geometry or material may also be connected optically to one or more electroluminescent light sources. Depending on the arrangement of the light-converting element 3 relative to the LED, the filter layer 7a, 7b, 7c, 7d may be differently arranged than in the embodiments that are shown by way of example in FIGS. 1 and 2. What is crucial in this case is for the filter layer to be so arranged that at least part of the secondary radiation is incident on the filter layer for absorption beyond the boundary wavelength, or in other words that part of the secondary radiation does not pass through the filter layer. For specific embodiments, it may be advantageous for not the whole of the secondary light to be absorbed beyond the boundary wavelength. This can be achieved on the one hand with a filter layer through which, due to its arrangement, the whole of the secondary radiation passes, if the absorptive capacity is reduced by varying the thickness of the layer or concentrating the pigments. As an alternative to this, the filter layer may also be so arranged that part of the secondary radiation does not have to pass through the filter layer.

The filter layer is composed for example of pigment materials that are preferably stable at temperatures of up to 200° C. over a long period and at high luminous fluxes, or of dielectric layers having alternately high and low refractive indexes.

Thermally stable inorganic pigment materials comprise, for different spectral ranges for example, the following materials:

| | |
|---|---|
| Blue: | CoO—Al₂O₃ |
| | Ultramarine |
| Green | TiO₂—CoO—NiO—ZrO₂ |
| | CeO—Cr₂O₃—TiO₂—Al₂O₃ |
| | TiO₂—ZnO—CoO—NiO |
| Yellow: | Bi-vanadate |
| | (Pr, Z, Si) oxide |
| | (Ti, Sb, Cr) oxide |
| | Ta oxinitride |
| Red: | Fe₂O₃ |
| | (Zn, Cr, Fe) oxide |
| | CdS—CdSe |
| | TaON. |

The pigment materials are preferably used in particle sizes <200 nm for producing the filter layer, the particles being uniformly distributed in a non-scattering matrix material. As well as these, what may also be used for the temperature range aimed at are stable organic pigment materials from the group of metal phthalcyanines or perylenes.

Where the pigments are inorganic, the matrix material that is used to apply the filter layer may be removed, e.g. by heating to T=350° C. in air. The stability of the filter layer can be increased in this way.

So that the phosphor-converted electroluminescent device according to the invention is able to provide for the application an adequate quantity of light beyond the boundary wavelength or between two boundary wavelengths, it is important for phosphor materials of a particularly high efficiency (i.e. having as low as possible a re-absorptive capacity for secondary radiation) to be used for the light-converting element. These materials should have a transmission of more than 30% for secondary radiation (when the light is incident parallel to the normal to the surface), and higher transmission values of 40% or more would be even more advantageous. Organic or inorganic phosphor materials of this kind can be produced in various ways:

a) as polycrystalline ceramic material that, by pressing and sintering the phosphor material is produced in a density of more than 95% of the theoretical density of the solid.

b) as a phosphor monocrystal.

c) as an inorganic or organic phosphor material embedded in a matrix material, with the refractive indexes of the matrix material and the phosphor material differing by less than 0.1.

The inorganic phosphor materials for efficient light-converting elements of this kind comprise for example materials from the groups

(M^{I}_{1-x-y}M^{II}ₓM^{III}_{y})₃(Al_{1-z-v}M^{IV}_{z}M^{V}ᵥ)₅O₁₂₋ᵥNᵥ

where M^{I}=(Y, Lu); M^{II}=(Gd, La, Yb); M^{III}=(Th, Pr, Ce, Er, Nd, Eu); M^{IV}=(Ga, Sc) and M^{V}=(Si, Ge) and 0≦v≦1; 0≦x≦1; 0≦y≦0.1 and 0≦z≦1,

M^{I}ₓ^{v+}Si₁₂₋₍ₘ₊ₙ₎Alₘ₊ₙOₙN₁₆₋ₙ,

where M^{I}=(Li, Mg, Ca, Y, Sc, Ce, Pr, Nf, Sm, Eu, Gd, Th, Dy, Ho, Er, Tm, Yb, Lu) and x=m/v,

(M^{I}_{1-x-y}M^{II}ₓM^{III}_{y})₂O₃

where M^{I}=(Y, Lu); M^{II}=(Gd, La, Yb) and M^{III}=(Th, Pr, Ce, Er, Nd, Eu, Bi, Sb) and 0≦x≦1 and 0≦y≦0.1,

(M^{I}_{1-x-y}M^{II}ₓM^{III}_{y})S_{1-z}Se_{z}

where M^{I}=(Ca, Sr, Mg, Ba); M^{II}=(Ce, Eu, Mn, Th, Sm, Pr, Sb, Sn) and M^{III}=(K, Na, Li, Pb, Zn) and 0≦x≦0.01; 0≦y≦0.05 and 0≦z≦1,

(M^{I}_{1-x-y}M^{II}ₓM^{III}_{y})O

where M^{I}−(Ca, Sr, Mg, Ba); M^{II}=(Ce, Eu, Mn, Th, Sm, Pr) and M^{III}=(K, Na, Li, Pb, Zn) and 0≦x≦0.1 and 0≦y≦0.1,

M^{I}₂₋ₓM^{II}ₓSi₂O₂N₂

where M^{I}=(Ca, Sr, Mg, Ba); M^{II}=(Ce, Eu, Mn, Th, Sm, Pr, Yb) and 0≦x≦0.1,

M^{I}₂₋ₓM^{II}ₓSi_{5-y}M^{III}_{y}O_{y}N_{8-y}

where M^{I}=(Ca, Sr, Mg, Ba); M^{II}=(Ce, Eu, Mn, Th, Sm, Pr, Yb) and M^{III}=(Al, B, Sc, Ga) and 0≦x≦0.1 and 0≦y≦4,

(M^{I}₂₋ₓM^{II}ₓM^{III}₂)O₇

where M^{I}=(La, Y, Gd, Lu, Ba, Sr); M^{II}=(Eu, Th, Pr, Ce, Nd, Sm, Tm) and M^{III}=(Hf, Zr, Ti, Ta, Nb) and 0≦x≦1,

(M^{I}₁₋ₓM^{II}ₓM^{III}_{1-y}M^{IV}_{y})O₃

where M^{I}=(Ba, Sr, Ca, La, Y, Gd, Lu); M^{II}=(Eu, Th, Pr, Ce, Nd, Sm, Tm); M^{III}=(Hf, Zr, Ti, Ta, Nb) and M^{IV}=(Al, Ga, Sc, Si) and 0≦x≦0.1 and 0≦y≦0.1.

What notation such as for example M^{I}=(Ca, Sr, Mg, Ba) for M^{I} is intended to mean in this case is not only the individual elements but also mixtures of the elements that are shown in parentheses.

Organic phosphor materials for efficient light-converting elements of this kind are for example Lumogen materials based on perylene dyes that are embedded in matrix materials such as for example PMMA. Highly efficient transparent materials can be obtained that cover the color space from yellow through orange, red, blue and green. It is also possible for phosphor materials in powder form, such as are used in conventional deposition techniques, to be processed into light-converting elements in wafer form. For this purpose, powdered phosphor is mixed into an organic (e.g. PMMA, PU, etc.) or inorganic (e.g. Al₂O₃) matrix material, processed into wafers and fractionated.

The intensity distribution of the emission spectrums of phosphor-converted electroluminescent devices according to the invention in comparison with corresponding pcLEDs without a filter layer, and the color points obtained with these spectrums in the CIE1931 diagram are shown by reference to three embodiments in FIGS. 3 and 4, 5 and 6, and 7 and 8.

FIG. 3 shows the emission spectrums of a blue emitting LED (mean emission wavelength of 452 nm) that has on the light-converting element, in an arrangement as shown in FIG. 1, a 1000 μm thick, transparent (Y_{0.7}Gd_{0.3})₃Al₅O₁₂:Ce(1%), Pr(0.1%) ceramic without a filter layer (solid curve 31), and with a 0.3 μm thick Fe₂O₃ filter layer (Sicotrans 2816) (dashed curve 71). As shown in FIG. 4, a yellow signal color is produced in this way with the filter layer (311: color point of a pcLED without a filter layer; 711: color point of a pcLED with a filter layer). The efficiency of light-conversion is approximately 50%. This is more than is obtained with a scattering phosphor-powder layer (having a suitable emission spectrum).

FIG. 5 shows the emission spectrums of a blue emitting LED (mean emission wavelength of 461 nm) and of a 200 μm thick translucent SrSi₂O₂N₂:Eu(2%) ceramic without a filter layer (solid curve 32) and with a 0.3 μm thick TiO₂—ZnO—CoO—NiO filter layer (Dainichiseika TM3330) (dashed curve 72) on the light-converting element in an arrangement as shown in FIG. 1. As shown in FIG. 6, a green signal color is obtained in this way with the color filter (321: color point of a pcLED without a filter layer; 721: color point of a pcLED with a filter layer). The efficiency of light-conversion is approximately 70%. This is more than is obtained with a scattering phosphor-powder layer (having a suitable emission spectrum).

FIG. 7 shows the emission spectrums of a blue emitting LED (mean emission wavelength of 455 nm) and of an 800 μm thick transparent (Y_{0.7}Gd_{0.3})₃Al₅O₁₂:Ce(1%), Pr(0.2%) ceramic without a filter layer (solid curve 33) and with a 2 μm thick TaON filter layer (Cerdec) (dashed curve 73) on the light-converting element in an arrangement as shown in FIG. 1. As shown in FIG. 8, an amber signal color is obtained in this way with the color filter (331: color point of a pcLED without a filter layer; 731: color point of a pcLED with a filter layer). The efficiency of light-conversion is approximately 60%. This is more than is obtained with a scattering phosphor-powder layer (having a suitable emission spectrum).

The embodiments that have been elucidated by reference to the drawings and in the description merely represent examples of a phosphor-converted electroluminescent device according to the invention and are not to be construed as limiting the claims to these examples. Alternative embodiments that are likewise covered by the scope of protection afforded by the claims will also be readily apparent to the person skilled in the art. The numbering of the dependent claims is not intended to imply that other combinations of the claims do not also constitute advantageous embodiments of the invention.

1. A phosphor-converted electroluminescent device comprising an electroluminescent light source (2) for emitting primary radiation, a light-converting element (3) having a phosphor material for at least partly converting the primary radiation into secondary radiation, and a filter layer (7a, 7b, 7c, 7d) for absorbing that secondary radiation incident on the filter layer (7a, 7b, 7c, 7d) that lies beyond at least one boundary wavelength in the spectrum of the emitted secondary radiation.

2. A phosphor-converted electroluminescent device as claimed in claim 1, characterized in that the filter layer (7a, 7b, 7c, 7d) absorbs the secondary radiation below a first boundary wavelength and above a second boundary wavelength.

3. A phosphor-converted electroluminescent device as claimed in claim 1, characterized in that the light-converting element (3) is coupled to the electroluminescent light source (2) optically.

4. A phosphor-converted electroluminescent device as claimed in claim 3, characterized in that the filter layer (7a, 7b, 7c, 7d) is arranged on that side of the light-converting element (3) that is remote from the electroluminescent light source (2).

5. A phosphor-converted electroluminescent device as claimed in claim 1, characterized in that the filter layer (7a, 7b, 7c, 7d) is arranged on an optical device (6) that at least partly encloses the electroluminescent light source (2) and the light-converting element (3).

6. A phosphor-converted electroluminescent device as claimed in a claim 1, characterized in that the filter layer (7a, 7b, 7c, 7d) comprises at least one material from the group of inorganic or organic pigment materials.

7. A phosphor-converted electroluminescent device as claimed in claim 6, characterized in that the pigment material is thermally stable up to 200° C.

8. A phosphor-converted electroluminescent device as claimed in claim 7, characterized in that the pigment material comprises at least one material from the group comprising CoO—Al₂O₃, TiO₂—CoO—NiO—ZrO₂, CeO—Cr₂O₃—TiO₂—Al₂O₃, TiO₂—ZnO—CoO—NiO, Bi-vanadate, (Pr,Z,Si)—O, (Ti,Sb,Cr)—O, Ta oxinitride, Fe₂O₃, (Zn,Cr,Fe)—O, CdS—CdSe, TaON or ultramarine (Na₈₋₁₀Al₆Si₆O₂₄S₂₋₄).

9. A phosphor-converted electroluminescent device as claimed in claim 1, characterized in that the filter layer (7a, 7b, 7c, 7d) comprises a layer system comprising layers having alternately high and low refractive indexes.

10. A phosphor-converted electroluminescent device as claimed in claim 1, characterized in that the light-converting element (3) has a transmission of more than 30% for secondary radiation having a direction of propagation parallel to the normal to the surface of the light-converting element (3).

11. A phosphor-converted electroluminescent device as claimed in claim 10, characterized in that the phosphor material is a polycrystalline ceramic having a density greater than 95% of the theoretical density of the solid, or a phosphor monocrystal.

12. A phosphor-converted electroluminescent device as claimed in claim 10, characterized in that the light-converting element (3) comprises a matrix material having phosphor material embedded in it, in which case the refractive indexes of the matrix material and the phosphor material differ by less than 0.1.

13. A phosphor-converted electroluminescent device as claimed in claim 1, characterized in that the phosphor material comprises at least one material from the groups
(M^{I}_{1-x-y}M^{II}ₓM^{III}_{y})₃(Al_{1-z-v}M^{IV}_{z}M^{V}ᵥ)₅O₁₂₋ᵥNᵥ
where M^{I}=(Y, Lu); M^{II}=(Gd, La, Yb); M^{III}=(Tb, Pr, Ce, Er, Nd, Eu); M^{IV}=(Ga, Sc) and M^{V}=(Si, Ge) and 0≦v≦1; 0≦x≦1; 0≦y≦0.1 and 0≦z≦1,
M^{I}ₓ^{v+}Si₁₂₋₍ₘ₊ₙ₎Alₘ₊ₙOₙN₁₆₋ₙ,
where M^{I}=(Li, Mg, Ca, Y, Sc, Ce, Pr, Nf, Sm, Eu, Gd, Tb, Dy, Ho, Er, Tm, Yb, Lu) and x=m/v,
(M^{I}_{1-x-y}M^{II}ₓM^{III}_{y})₂O₃
where M^{I}=(Y, Lu); M^{II}=(Gd, La, Yb) and M^{III}=(Tb, Pr, Ce, Er, Nd, Eu, Bi, Sb) and 0≦x≦1 and 0≦y≦0.1,
(M^{I}_{1-x-y}M^{II}ₓM^{III}_{y})S_{1-z}Se_{z}
where M^{I}=(Ca, Sr, Mg, Ba); M^{II}=(Ce, Eu, Mn, Tb, Sm, Pr, Sb, Sn) and M^{III}=(K, Na, Li, Pb, Zn) and 0≦x≦0.01; 0≦y≦0.05 and 0≦z≦1,
(M^{I}_{1-x-y}M^{II}ₓM^{III}_{y})O
where M^{I}=(Ca, Sr, Mg, Ba); M^{II}=(Ce, Eu, Mn, Tb, Sm, Pr) and M^{III}=(K, Na, Li, Pb, Zn) and 0≦x≦0.1 and 0≦y≦0.1,
M^{I}₂₋ₓM^{II}ₓSi₂O₂N₂
where M^{I}=(Ca, Sr, Mg, Ba); M^{II}=(Ce, Eu, Mn, Tb, Sm, Pr, Yb) and 0≦x≦0.1,
M^{I}₂₋ₓM^{II}ₓSi_{5-y}M^{III}_{y}O_{y}N_{8-y}
where M^{I}=(Ca, Sr, Mg, Ba); M^{II}=(Ce, Eu, Mn, Tb, Sm, Pr, Yb) and M^{III}=(Al, B, Sc, Ga) and 0≦x≦0.1 and 0≦y≦4,
(M^{I}₂₋ₓM^{II}ₓM^{III}₂)O₇
where M^{I}=(La, Y, Gd, Lu, Ba, Sr); M^{II}=(Eu, Tb, Pr, Ce, Nd, Sm, Tm) and M^{III}=(Hf, Zr, Ti, Ta, Nb) and 0≦x≦1,
(M^{I}₁₋ₓM^{II}ₓM^{III}_{1-y}M^{IV}_{y})O₃
where M^{I}=(Ba, Sr, Ca, La, Y, Gd, Lu); M^{II}=(Eu, Tb, Pr, Ce, Nd, Sm, Tm); M^{III}=(Hf, Zr, Ti, Ta, Nb) and M^{IV}=(Al, Ga, Sc, Si) and 0≦x≦0.1 and 0≦y≦0.1.

14. A phosphor-converted electroluminescent device as claimed in claim 12, characterized in that the phosphor material is a Lumogen material.

15. Use of a phosphor-converted electroluminescent device as claimed in claim 1 as a light source in a vehicle.
